(19) United States
(12) Patent Application Publication
(10) Pub. No.: US 2026/0242249 A1
(43) Pub. Date: Aug. 20, 2026

(54) Plastic micro- and nanoparticle removal process and devices

(71) Applicant: Mark Edward Jones, Midland, MI (US)

(72) Inventor: Mark Edward Jones, Midland, MI (US)

(21) Appl. No.: 19/056,017

(22) Filed: Feb. 18, 2025

(51) Int. Cl. C02F 1/28; A23L 2/70; A23L 2/80; A23L 5/20; C02F 1/26; C02F 101/30

(52) U.S. Cl. CPC C02F 1/285; A23L 2/70; A23L 2/80; A23L 5/23; A23L 5/273; C02F 1/26; C02F 2101/30

(57) ABSTRACT

The invention describes removal of microparticles and nanoparticles of plastic from water, beverages and other water-based liquids using particle capturing solids and devices based on particle capturing solids. Particle capturing solids described include resilient thermoplastic polymers and lipophilic water-insoluble oils that are solids at room temperature. Devices are described that use particle capturing solids, facilitating easy introduction and retrieval from water, beverages and other water-based liquids.

### TECHNICAL FIELD

Inventions described herein relate to methods and devices suitable for separation of polymer micro- and nanoparticles suspended in aqueous systems. Inventions described herein provide means for reduction and removal of plastic micro- and nanoparticles from water, beverages and other water-based mixtures.

### BACKGROUND OF THE INVENTION

Plastic micro- and nanoparticles are of increasing concern in food and beverages. Recent studies emphasize the presence of particles in bottled water and other packaged beverages. In early 2024, researchers determined that up to 240,000 particles could be present in commercial PET (polyethylene terephthalate) bottled water [Naixin Qian; Xin Gao; Xiaoqi Lang; Huiping Deng; Teodora Maria Bratu; Qixuan Chen; Phoebe Stapleton; Beizhan Yan; and Wei Min; “Rapid single-particle chemical imaging of nanoplastics by SRS microscopy”, Proceedings of the National Academies of Science and Engineering, Jan. 8, 2024, 121 (3). https://doi.org/10.1073/pnas.2300582121]. Like previous research, it implicates particles present in the liquid being bottled and shed by the packaging itself. Particle shedding is not well understood, though handling of bottles is implicated in creating particles. It is, therefore, insufficient to remove particles only at the time of filling. While better removal at the time of filling will clearly reduce the potential for particle exposure, particles generated in the bottle, either as a result of forming the bottle or by shedding after filling, are not impacted by better particle removal during filling. Particles must be removed at or near the time of consumption or use if they are to be avoided. Additionally, prepared drinks, such as coffee prepared using single-serve pods or tea, may introduce particles during preparation. Again, particle removal at or near the time of consumption is required to reduce exposure to plastic micro- and nanoparticles.

Particle removal technologies are well known. Filtration is awkward in the context of a portable water bottle where consumers most commonly drink directly from the bottle. The potential for containers to shed particles during filling, shipment and handling necessitates particle removal immediately prior to consumption. Filtration is impractical in many use cases. It requires equipment, use of controlled porosity media and requires a relatively large surface area filter. It is both time and material inefficient for particle removal. Application to portable containers requires additional weight and complexity that is not compatible with maximum portability.

Centrifugation is another means of removing particles from liquids. It is equipment intensive and also not well suited for portable containers when used on-the-go.

Microplastic removal using extraction into water immiscible solvents has been demonstrated for sampling microplastics. Plastic nanoparticle removal using lipophilic water immiscible solvents has not been described. Water immiscible solvent extraction has not been described as a means to reduce exposure to either plastic micro- or nanoparticles. It has not been described for nanoparticle sampling. Use of solvents presents challenges. Hydrocarbon solvents, while they work quite well, present safety and health challenges. Liquids are messy during use and complete separation of the immiscible layers is difficult. Use of water immiscible solids provides a clear advantage. The method for using solids capable of capturing plastic micro- and nanoparticles is herein disclosed. Devices using solids capable of capturing plastic micro- and nanoparticles are herein disclosed. Removal of plastic micro- and nanoparticles using food oils that are solids at ambient conditions is herein disclosed.

### SUMMARY OF THE INVENTION

The invention is a process and devices based on the process for removing plastic micro-and nanoparticles from water, beverages and other liquids. The process relies upon solid particle capturing materials with affinity for plastic micro- and nanoparticles in the presence of water. Use of a solid to capture plastic micro- and nanoparticles is advantaged due to the ease of separation of the solid after exposure to and capture of plastic micro- and nanoparticles. A solid, as used here, is not a free-flowing liquid or gas. A solid is a material with sufficient structure as to be able to hold it shape. Many solids melt, becoming free-flowing liquids. Thus, solid is a descriptor of a state, not an intrinsic property of a material. Solids useful in the invention are most commonly, but not exclusively, soft, resilient materials. Solids useful in the invention are solids after exposure to aqueous liquids. The solid material must have sufficient mechanical integrity to allow easy mechanical separation from aqueous media. It must, therefore, remain solid in aqueous media. Many solids dissolve in water. Such materials become impossible to mechanically separate from water and are not useful here. As used here, a solid object of a certain shape, in the absence of applied force, will remain in that shape. A solid, as used here, must have sufficient structure to be mechanically manipulated to be separated from a liquid. A material capable of being lifted by a coarse screen or on a fork is, therefore, a solid. Liquid materials that become solid upon exposure to liquid, change in temperature, or other means can be used in the invention. A defining characteristic of the invention is that particles are contained or adhered to a solid material that is easily mechanically separated from the liquid after particle capture.

Plastic micro- and nanoparticles are not consistently defined. Used herein, the term means particles with all major dimensions less than 5 mm. Plastic is meant as a synonym of polymeric. Plastic particles, as used herein, comprise synthetic, man-made polymers. Examples include, but are not limited to, polyethylene, polypropylene, polyethylene terephthalate (PET), polyacrylate, polyamide, polyvinylchloride, polyurethanes, polyepoxides, and synthetic rubber. Plastic particles, as used herein, can also refer to naturally occurring polymeric materials such as, but not limited to, cellulose and cellulose derivatives, and naturally occurring polyesters.

The particle capturing solid is portable, material efficient, and does not require complicated technology or operation. In one embodiment, water immiscible tacky, elastomeric, polymeric solids are employed. Such polymers find use as removable and permanent pressure sensitive adhesives. Appropriate polymers are lipophilic, water immiscible, unreactive with water, and made of polymers recognized as food safe. These polymers are commonly thermoplastic materials, but can be resilient thermoset materials. In the second embodiment, lipophilic, water immiscible oils and waxes that are solids at near room temperature are used. These may be, but are not limited to, natural or artificial, fully saturated, partially saturated or unsaturated, untreated, partially hydrogenated or fully hydrogenated esters, acids or other derivatives. Wax is a chemically ambiguous term, encompassing many naturally occurring esters of fatty acids both pure and in mixtures, and also is used to describe materials, such as but not limited to paraffin and polyolefin waxes, that are fossil-derived or chemically produced. Used here, wax is intended to encompass both chemical descriptions. Use of naturally occurring food-grade oils, triglycerides of fatty acids, fall within this embodiment. Examples include but are not limited to coconut oil, animal fat, and vegetable shortening (commonly associated with the brand Crisco®). Use of aliphatic materials, such as paraffin or polyolefin waxes also are useful in this embodiment. Useful materials must be immiscible with water, unreactive with water, and food safe.

Use of solid particle capturing materials is key aspect of the process of removing plastic micro- and nanoparticles from water, beverages or other liquids. Several devices using particle capturing solids are also described. These devices provide a means for introducing solid particle capturing materials to water, beverages or other liquids, providing contact with plastic micro-and nanoparticles contained in the liquid, and sequestering for removal the plastic micro-and nanoparticles present in the liquid. A benefit derived is that plastic micro- and nanoparticles ingestion can be reduced or eliminated.

The invention makes use of polymer affinity for certain materials being greater than affinity for water. This is particularly true for polyethylene terephthalate (PET) and polyethylene (PE) found in water bottles due to their use as bottle and cap polymers, respectively. It is also true for polyamide polymer particles found in beverages, presumably shed from processing equipment, whether in the factory or home. Home devices include, but are not limited to, filters, pod coffee makers and tea bags.

### BRIEF DESCRIPTION OF DRAWINGS

FIG. 1: Two vials to which a suspension of approximately 0.1 g/L of PET particles in water have been added. The left vial is the suspension in an unaltered vial. The right vial contains particle capturing polymer melted into the base of the vial prior to addition of the suspension. Particles are visible on the upper surface of the particle capturing polymer and are no longer visible, having been captured on the surface of the particle capturing polymer, from the suspension.

FIG. 2: Comparison of the 10:1 diluted stock suspension before and after treatment with particle capturing material. The top photo is of the starting 10:1 diluted stock suspension under illumination by a 5 mW red laser with a beam diameter of 4.4 mm. The bottom photo is under identical conditions but illuminating after exposure to the particle capturing material.

FIG. 3: An optical micrograph of some of the particles removed from vodka using a device consisting of particle capturing polymer on a metal washer. There is one large particle and several smaller particles present on the polymer surface. The metal washer was placed in a vodka sample, allowed to contact the vodka, and retrieved with a magnet for examination using the microscope.

FIG. 4: An optical micrograph taken under UV-C illumination of some of the particles removed from coffee prepared using a coffee pod and a Keurig brand pod coffee maker. The pod was a Pikes Place® Roast. Particle capturing polymer was melted onto a glass microscope slide and allowed to cool to form a particle capturing device. The device, consisting of the glass slide and adhering particle capturing polymer, was used to stir the coffee in a way that caused contact of the particle capturing polymer with the coffee. The device was removed from the coffee and shaken to remove liquid. It was examined using an optical microscope using reflected UV-C illumination since some of the captured particles were fluorescent.

FIG. 5: Particles on the surface of a commercially available pressure sensitive adhesive sold as Glue Dots (sold by Glue Dots International). Partilces are on the surface of a 13 mm (½ inch) repositionable glue dot previously pressed into the cap of a commercial bottled water (Meijer spring water), 500 mL size. After exposure to the water, the dot was removed and examined using the microscope.

FIG. 6: Particles on the surface of thermoplastic polymer after exposure to commercial water packaged in a coated paper carton with a screw lid (Flow brand). The device used to introduce particle capturing polymer to the water consisted of a 0.01 g piece of gel window cling polymer (Hobby Lobby brand) melted into the center of a #8 star washer. After exposure to the water, the device was removed and examined using the microscope.

FIG. 7: Scattering of a 5 mW green laser by particles present in commercial Flow brand water packaged in a coated paper carton with a screw lid before and after treatment. Treatment used a device consisting of 0.01 g piece of gel window cling polymer (Hobby Lobby brand) melted into the center of a #8 star washer. Scattering is considerably reduced in the treated sample indicating reduction in the number of nanoparticles present.

FIG. 8: Scattering of a 5 mW green laser by particles present in commercial contact lens solution (Bausch+Lomb Sensitive Eyes® Saline Solution) before and after treatment. Treatment used a device consisting of 0.01 g piece of gel window cling polymer (Hobby Lobby brand) melted into the center of a #8 star washer. Scattering is considerably reduced in the treated sample indicating reduction in the number of nanoparticles present.

FIG. 9: Two vials. On the left is the standard particle-containing suspension. The suspension was a 10:1 dilution of the stock suspension made by abrading a PET water bottle with a high-speed grinder under water. On the right is the same particle containing suspension after treatment with coconut oil. Visible particles are gone, now trapped in the solid coconut oil.

FIG. 10: Comparison of the standard suspension and the coconut oil-treated sample. In each case, a drop was allowed to dry for examination using the optical microscope in transmission mode (illuminated from below). The standard shows a high number of particles. These particles have been removed from the sample. Residual oil droplets were observed from the treated sample.

### DETAILED DESCRIPTION OF THE INVENTION

The invention is a process and devices based upon that process for removing plastic micro- and nanoparticles from beverages or other liquids. Solid particle capturing material is used in the process and is a component of devices based upon the process. The particle capturing solid material can fall into one of two broad classes. One class is tacky, elastomeric polymers. This class can be used over temperatures where water is liquid, between the freezing point and boiling point of water. These are 0° C. and 100° C., respectively. Most preferred temperatures are between 5° C. and 85° C. (a typical temperature for hot beverages such as coffee or tea). The second class is fatty acids, fatty acid derivatives and waxes that are solids at temperatures suitable for use with water-containing beverages and liquids. This encompasses temperatures falling between the melting point of ice and the boiling point of water. Most preferred temperatures are in the range between 2° and 50° C. In the preferred embodiment, water, beverages or other liquids are heated sufficiently to melt a chosen fatty acid, fatty acid derivative or wax, and then cooled sufficiently to solidify the fatty acid or derivative. Solidifying the melted fatty acid, fatty acid derivative or wax forms a solid disc on the surface of the water, beverage or other liquid. That is, fatty acids, fatty acid derivatives and waxes typically are less dense than water and float on the surface. The solid material, having captured particles from the liquid can be removed or avoided for consumption or use. Removal or avoidance is made easier by a reduced number of solid particles. That is, allowing or encouraging added fatty acids, fatty acid derivatives or waxes to coalesce into only a small number, preferably only one, globule prior to solidifying improves the ability to avoid or remove the solid after particle collection. In some configurations, it may be advantageous to use more oil than is needed for particle capture so that retrieval or avoidance is enhanced.

The invention includes but is not limited to devices consumers add prior to beverage consumption, bottles containing added particle capturing material, devices that can be temporarily introduced to a liquid such as a coated object, spoon or straw, and stickers suitable for temporarily affixing to bottles, cups, mugs and other drinking implements. It also includes devices added at the time of manufacture or incorporated into the bottle.

The invention also includes the process using solid fatty acids, fatty acid derivatives or waxes added either as solids or as liquids after melting at elevated temperatures. Melted fatty acids, fatty acid derivatives or waxes may be added to samples to remove particles. Solids can be added and subsequently melted to improve particle capture but this is not required. Modest heating also allows formation of a larger, and in some cases a single, solid disc to be removed, but this is not required. Key to the embodiment is ensuring the particle capturing material has solidified for separation from the water, beverage or other liquid. The solidified fatty acid, fatty acid derivative or wax is removed from the water, beverage or other liquid after capturing plastic micro- and nanoparticles. Removal prior to consumption or providing a means to avoid consumption via mechanical means avoids exposure to the captured particles. Mechanical means include but are not limited to decantation, use of a separatory funnel, or a straw to consume the water or beverage from below the solidified fatty acid, fatty acid derivative or wax.

In one embodiment, the particle capturing material is a resilient polymer. It can be produced on release film sheets. Glue dots are an example of a resilient polymer produced on release film for application. In use, the particle capturing material is transferred from release film into the bottle, the bottle's lid or to other object for introduction into the bottle. Once inside the bottle, steps are taken to contact the particle capturing material with the contents of the bottle. Swirling and inverting the bottle to expose the liquid to the particle capturing material reduces or eliminates plastic micro- and nanoparticles in the liquid. In this process, particles introduced during filling or created from the packaging are both reduced or eliminated from the liquid prior to consumption. Polymers suitable must be food safe.

In another embodiment, particle capturing material is placed in bottles prior to filling. Particles introduced during filling and those created subsequently will be significantly reduced or eliminated from the liquid consumed over the life of the container. In this form, the device is added by manufacturers, not by consumers. The particle capturing material can be sufficiently adhesive to affix mechanically to the surface of the bottle. Alternatively, it may be possible to mold the material into the bottle, making the bottle the capture device. Alternatively, mechanical attachments may be employed.

In another embodiment, particle capturing material is used without attachment to the bottle or other container. In one embodiment, a suitably sized piece of particle capturing material is introduced to the container. Several of the particle capturing polymers float in water and beverages. The particle capturing material can be used in this configuration. Performance may be improved by adjusting the density of the particle capturing material to be neutrally buoyant or denser than the beverage or liquid to be treated. The device is a formed object suitable for addition to beverages or other liquids made from a physical mixture of particle capturing polymer with filler or fillers used to adjust density. The particle capturing material can be a physical mixture with a material with appropriate density to yield the desired mixture density. Higher density materials are used to make the physical mixture denser than the beverage or liquid being treated to remove plastic micro- and nanoparticles. Additives can be granular or regular solids. Examples include but are not limited to silica particles, metal or metal oxide particles, metal carbide particles, glass beads, and silica or plastic hollow spheres. Melted particle trapping material can be mixed with granular or regular solids and allowed to solidify. Physical mixtures can also be used to alter physical properties to aid in recovery of the particle capturing material. A device for plastic particle removal is formed by application of the solid particle capturing material to a substrate to facilitate easy introduction and removal from the water, beverage or other liquid. An example sample is a disc or square of polyester sheet. Particle trapping material can be melted and applied or applied from release material. Suitable materials include but are not limited to glass, plastic, metal and ceramics. The substrate material used to support the particle capture material can be reused.

In a similar embodiment, a device is formed by addition of particle capturing material to an object to be introduced into the liquid. In one embodiment of this case, a small amount of particle capturing material is introduced to the surface of a spoon. Swirling the spoon in the liquid will allow plastic micro- and nanoparticles to adhere to the particle capturing material, reducing or eliminating them in the liquid. Other options include but are not limited to straws, stirring sticks, and disposable plastic sheets, either flexible or rigid. The particle capturing material can be sold to the consumer in a way to allow it to be temporarily affixed to the object at time of use. In another, devices may be sold with particle capturing material affixed and intended for single or limited number of uses. Sold to the consumer is a way suitable for temporary attachment, only the particle capturing material is disposed of after use. An embodiment is the attachment of particle capturing material to an object introduced but easily retrieved from the bottle, cup or other drinking implement. An example is a magnetic disc or washer covered with particle capturing material. Such a disc can be held in the lid of a bottle with a magnet. The bottle can be inverted and swirled to contact the liquid with the particle capture material. The bottle can be returned to upright and the lid, with the magnetically retained particle capture material covered metal disc or washer, removed. Separating the magnet from the lid releases the device. Alternatively, the particle capturing material may be on a device incapable of escaping from the bottle. An example is a plastic disk or other shape larger than the bottle opening covered in particle capturing material. Such a device could be distorted for insertion through the bottle opening but would return flat once in the bottle. An example is a washer shaped piece of flat polyester film. A washer shape is a disc with an internal hole, shaped like commercially available metal flat washers. A plastic film washer can be rolled yet will spring back to flat once released. Covering such a washer shape with particle capturing material, including or not the inner diameter, would allow introduction of particle capturing material to a bottle while providing mechanical means to retain it in the bottle.

The devices and process described use a particle capturing solid material. The invention relies on the recognition that the plastic micro- and nanoparticles present in beverages and other liquids are inherently lipophilic. This trait was demonstrated with microplastics by Lechthaler [Lechthaler, Simone Elisabeth; “Microplastics in the environment: development of a sample preparation method with further application and evaluation in fluvial and marine compartments”, dissertation, Rheinisch-Westfälische Technische Hochschule Aachen, 2021 DOI: 10.18154/RWTH-2021-05018;publications.rwth-aachen.de/record/819390/files/819390.pdf]. Lechthaler used liquids to capture particles. The invention described herein extends the work of Lechthaler upon recognition of the capabilities of tack, elastomeric solids to trap lipophilic polymer micro- and nanoparticles. The devices and process described herein use particle capturing materials that are solids when used to remove particles. Solid particle capturing materials make removal of the capturing material and the captured particles far simpler than using liquid particle capturing materials.

Affinity of the small polymer particles to the polymer surface even when submerged in water or other beverage allows collection of the plastic micro- and nanoparticles for removal from water and beverages from several tested thermoplastic polymers. As described above, thermoplastic polymers can be added to the water or beverage and recovered prior to consumption having reduced or eliminated plastic micro- and nanoparticles from the liquid. Polymer can be affixed to a substrate made of but not limited to glass, ceramic, metal, polymer, paper or wood. The requirement is for adhesion of the polymer to the substrate to allow immersion and retrieval from the water or beverage. Removal of the substrate bonded to the thermoplastic polymer from the water or beverage removes the plastic micro- and nanoparticles adhered to the polymer, reducing or eliminating the consumption of plastic micro-and nanoparticles when drinking water or other beverages.

Polymers useful in the current invention are insoluble in water and possess tacky surfaces. Examples of thermoplastics include fugitive adhesives, pressure sensitive adhesives sold as glue dots and for gel window clings. Fugitive adhesives are a class of low-tack adhesives conventionally encountered gluing things like credit cards to paper for sending in the mail. Glue dots are hot melt adhesives melted and applied to a coated release paper and pressed to make uniform, thin cylinders or discs of thermoplastic polymer. Application to surfaces involves touching the exposed glue to the surface and removal of the release paper. Removal of the release paper exposes the tacky surface of the glue, ready for bonding to another surface. Gel window clings are thermoplastic polymers with very low tack. They are made by pouring melted polymer into a mold. Once separated from the mold, the gel window cling is placed between two sheets of polymer for packaging and subsequent sale. Purchased window clings can be pressed against a surface, typically a window, for bonding. Gel is an ambiguous term, with several definitions used by those skilled in the art. Gel window clings are a homogeneous polymer and not a colloidal system of solids suspended in a liquid phase. Gel is used as a descriptor for the resilient, semi-solid nature of the window cling, not to denote a chemical composition.

Purchased glue dots and gel window clings can be melted at modest temperature by direct heating, by the action of a heat gun or by other means known to those skilled in the art. Placement of a glue dot or section of a gel window cling onto a suitable glass, metal, ceramic, polymer or other substrate allows creation of a thin, bubble-free polymer puddle that, upon cooling, can be readied for contact with water or other beverage. This can be by direct application to a bottle cap, by application to a release film for subsequent application to another surface or by application directly to an appropriate substrate suitable for immersion in water or other beverage.

After suitable exposure to the water or other beverage, the thermoplastic polymer is removed and discarded. The small amount of polymer required offers an advantage relative to more material intensive filtration. The technique is advantaged over centrifugation by requiring no complicated equipment.

Many thermoplastic polymers are known to those skilled in the art. They include but are not limited to ethylene-vinyl acetate polymers (EVA), high alphaolefin polyolefins, metallocene polyolefins, styrene block copolymers and more. Styrene block copolymers include, but are not limited to, styrene-butadiene-styrene (SBS) and styrene-ethylene-butadiene-styrene (SEBS) block copolymers. These materials and other suitable polymers can be made from feedstocks including fossil, recycled and biofeedstocks. While examples use polymers that are not biodegradable, in many envisioned applications biodegradable polymers could be used.

One skilled in the art may find resilient thermosets or crosslinked polymers that also are particle capturing. Examples may include but are not limited to silicones and polyurethanes.

One skilled in the art may find mixtures of polymers useful. Polymers may be blended or one coated on another. Mixtures of polymers may be mechanically bonded or chemically bonded.

The invention includes a method for using lipophilic, water immiscible oils, oil derivatives and waxes that are solids at near room temperature to capture particles. These may be, but are not limited to, natural or artificial, fully saturated, partially saturated or unsaturated, untreated, partially hydrogenated or fully hydrogenated esters, acids or other derivatives. Wax encompasses many naturally occurring esters of fatty acids both pure and in mixtures, and also is used to describe paraffin and polyolefin waxes that are petroleum-derived or chemically produced. Edible oils are preferred. Edible oils suitable here must be solids at easily obtained temperatures, preferably between 2° and 50° C. Most preferably, room temperature. Oils melting in hot water such as coconut oil or hydrogenated vegetable oil are two examples. Oils may be naturally occurring or synthetic. Use of naturally occurring food-grade oils, triglycerides of fatty acids, fall within this embodiment. Most common oils are triglyceride esters of fatty acids. Free acids or esters of fatty acids may also be used. Use of aliphatic materials, such as paraffin or polyolefin waxes also are useful in this embodiment. In use, oil and water form two phases. Plastic particles, both micro- and nanoparticles, are pulled into the oil phase. Discarding this phase removes the plastic from the water, beverage or liquid. Use of oils that solidify upon cooling creates chunks that are easily removed by mechanical means. The floating solid chunks are also easily avoided, such as by using a straw to drink from below the solidified oil, oil derivatives or wax. This is in contrast to the fluid globules formed by liquid oils when added to water which are difficult to remove and avoid.

Utility of the solid particle capturing materials was demonstrated by showing that particles were indeed removed from water, beverages and other liquids. This was demonstrated through use of two aqueous systems. The first consisted of suspensions of polymers produced from commercial water bottles and lids. These polymers have been shown to be significant components of the polymer particles present in commercial water bottles. Suspensions can be made at much higher plastic concentration for testing the efficiency of capture technology. The second system is commercially purchased liquids, including bottled water, alcoholic beverages and health care solutions. Utility with these samples was shown using optical laser techniques to image particles before and after introduction of particle removing materials. Additionally, optical microscopy was used to view captured particles on the surface of the polymers. Taken together, these techniques demonstrate the ability of particle capturing solid materials to remove or eliminate polymer micro- and nanoparticles from water, beverages and other liquids.

### EXAMPLES

Testing shows that many water immiscible solvents and oils draw microplastic particles from the water, consistent with and expanding the range of useful materials found by Lechthaler. Testing procedures were developed and used to validate the inventions described. The first was to develop a method for producing plastic micro- and nanoparticles consistent with those known to be present in beverages and other liquids, especially bottled water. Methods were developed to make high concentrations of plastic micro- and nanoparticles made from bottle and cap polymers. These were made by employing a high-speed grinder underwater. Underwater grinding provides several advantages. The first is that collection of the particles to make a suspension is intrinsic. Particles stay in the water and do not have to be collected for introduction to water, reducing loss and the potential for exposure. The second is that it keeps polymers being abraded cool. Small particles are made rather than strands of melted polymer. Sanding or grinding polymers in air created considerable melting. Using a handheld, high-speed grinder also provided considerable flexibility. Bits of different abrasiveness are readily available and can be manufactured. Bits made from bottle and filter polymers were found to make small particles. Speeds can be adjusted. The biggest advantage is that the polymer particles are produced from real world polymers, not model systems. They are made in a range of particle sizes, as is encountered in commercial water, beverage and other liquid samples. Subsequent filtering provides test media with a known maximum particle size. Exact concentration measurement is difficult since losses in the grinding are hard to counteract. Difference in weight measurements give an estimate particle concentration in the suspension. The translucent suspension is many times more concentrated than a typical commercial water bottle. A stock suspension is prepared by dilution to approximately 1 g/L, still more concentrated than a commercial water bottle. Dilution by 10 to 1000:1 made suspensions where microparticles were clearly visible under intense white light. Easily visible particles let a wide variety of particle capturing materials be evaluated.

The second component of the testing centers on measuring plastic micro-and nanoparticles is suspensions. Two techniques were used. Optical microscopy allows imaging polymer microparticles. The second technique is to image particles in the liquid. Under this envelope, three different light sources are used. The eye and cameras are detectors. Light sources are focused white light from an LED, a 5 mW red laser and a 5 mW green laser. Cameras used for detection include both an iphone 13 and a 50×-1000× handheld digital microscope. Laser Rayleigh scattering allows before and after concentration of plastic micro-and nanoparticles to be measured based on the work of Pui [Ye, Yan, and David YH Pui. “Detection of nanoparticles suspended in a light scattering medium.” Scientific reports 11, no. 1 (2021): 20268. https://www.nature.com/articles/s41598-021-99768-x]. This work demonstrates that microparticle concentration can be measured with the red laser. The green laser images the sum of micro- and nanoparticles. During the course of investigation, particles were captured and imaged on solid particle capturing materials from both prepared suspensions, from commercially purchased bottled water, from other beverages and from other water-based liquids. Observation under intense white light showed removal of larger microparticles. Rayleigh scattering also showed reduction and potential elimination of micro- and nanoparticles.

There are, however, shortcomings in this analysis. The first is the difficulty in obtaining particle-free water. Several authors have mentioned even highest quality lab waters still have particles. Testing shows that to be the case. Purchased distilled water used for testing contained detectable particles. Commercially purchased filters are found to shed particles, especially on first use. Getting water completely devoid of detectable particles has not been achieved in this testing. The optical laser technique employed is sensitive to all particles and bubbles. Inorganic, polymeric and biological particles all are observed without differentiation. Microscopic observation of captured microparticles can identify them as polymeric. Nanoparticles are not observed by the optical microscope.

### Comparative Example 1

### Test Mixture.

A suspension containing plastic micro- and nanoparticles is produced by contacting a polyethylene terephthalate (PET) water bottle with a rotating ½-inch sanding drum under water. In preparation, a 500-ml water bottle is heated with an electric heat gun. The softened bottle is twisted to make a semi-rigid structure. 35 ml of water is added to a 65 mm glass jar. The rotating sanding drum is held under water but not touching the bottom of the container. The water bottle is weighed. The rim of the water bottle is contacted for a period of about 30 seconds. This produces a translucent, milky liquid with some visible particles. The suspension is filtered through 110-120 mesh filters, nominally passing 125 micrometer and smaller particles, yielding a translucent suspension. Before and after weight of the PET bottle gives the total amount removed by grinding. Subtraction of the amount captured in the filter is subtracted to yield the total amount of particles less than 110-120 mesh in the mixture. Approximately 80% of the total weight loss is removed by filtering. The mixture is diluted to yield an approximate micro- and nanoplastic concentration of 1 g/L. This is the stock suspension used diluted for subsequent testing. The stock suspension was mixed well and an aliquot diluted 10:1 and repeated to yield suspensions at 10, 100 and 1000:1 concentration of the stock suspension.

Comparison with Known Technology for Particle Extraction.

Work by Lechthaler showed extraction of microplastics from water with lipophilic organic solvents was efficient [Lechthaler, Simone Elisabeth; “Microplastics in the environment: development of a sample preparation method with further application and evaluation in fluvial and marine compartments”, dissertation, Rheinisch-Westfälische Technische Hochschule Aachen, 2021 DOI: 10.18154/RWTH-2021-05018;publications.rwth-aachen.de/record/819390/files/819390.pdf]. For a comparison, Stoddard solvent [Park's brand paint thinner] was used. Approximately 1 mL of Stoddard solvent was added to a 17 mL glass vial containing approximately 10 ml of the stock suspension and shaken vigorously. The vial was allowed to phase separate for ~15 minutes. This is the sample vial. A standard was prepared by placing 10 ml of the stock suspension in a 17 mL glass vial. This is the standard vial.

### Observations and Measurements.

Direct observation of the sample and standard vials was done under three different illuminations. One used a white LED flashlight with focus, LETMY brand tactical style, 300 lumen zoomable LED flashlight. The second used a 5 mW 650 nm red laser diode, RLECS brand. The third a Qiaoba brand 5 mW 532 nm green laser diode. The white light and red laser image microparticles. As seen in the work of Pui [Ye, Yan, and David YH Pui. “Detection of nanoparticles suspended in a light scattering medium.” Scientific reports 11, no. 1 (2021): 20268. https://www.nature.com/articles/s41598-021-99768-x], nanoparticles are observable with the green laser. Detection was by Apple iPhone camera and with a Skybasic brand wireless digital microscope with 50×-1000× magnification.

Particles were easily observed in the standard under focused white light illumination. All particles visible under focused white light illumination we removed from the aqueous phase of the sample vial. Particles were clearly visible on the interface between the aqueous and immiscible organic phase. The organic phase, as expected was on top of the water. Particles were easily visible in the standard sample.

Illumination with the 5 mW red laser showed clearly visible particles in the standard suspension. None could be seen in the aqueous phase of the sample.

Illumination with the 5 mW green laser showed clear evidence of Rayleigh scattering in the standard. Very few scattering events were observed in the aqueous phase of the sample.

An aliquot was pulled from the aqueous phase of the sample and placed on a microscope slide. An aliquot was pulled from the standard and placed on a microscope slide. Both were allowed to dry. Examination by eye showed a white residue marked by visible particles from the standard. The sample dried undetectable. Both were examined using optical microscopy. The standard showed many particles. No particles of any kind were observed from the aqueous phase of the sample.

These experiments show the extraction of polymer particles from aqueous suspensions of PET particles derived from a water commercial bottle. Even at high concentrations of suspended polymer particles, reduction or elimination of polymer micro- and nanoparticles using lipophilic immiscible solvents.

### Comparative Example 2

The stock suspension of Comparative Example 1 was diluted 10:1 by weight. 5 mL of the 10:1 diluted suspension was placed in a 10 mL glass vial. 1 mL of Stoddard solvent was added and shaken vigorously. The vial was allowed to phase separate for ~10 minutes. 5 mL of the 10:1 diluted suspension was placed in a 10 mL glass vial to serve as a standard.

### Observations and Measurements.

The observations of Comparative Example 1 were repeated.

Particles were easily seen under focused white light illumination in the standard. No particles were visible under focused white light illumination in the sample.

Illumination with the 5 mW red laser showed clearly visible particles in the standard suspension. None could be seen in the aqueous phase of the sample.

Illumination with the 5 mW green laser showed clear evidence of Rayleigh scattering in the standard with too many particles to count accurately. Few scattering events were observed in the aqueous phase of the sample.

### Example 1

The stock suspension of Comparative Example 1 was diluted 10:1 by weight.

### Preparation of Particle Capturing Polymer.

0.05 grams was cut from a gel window cling (Hobby Lobby brand) and placed in a 17 mL glass vial. The gel was melted by heating the exterior of the vial with a heat gun. Once the gel was completely melted and had flowed to completely fill the bottom of the vial, it was allowed to cool. Approximately 10 ml of the 10:1 diluted stock suspension was added on top of the prepared polymer. The vial was shaken and allowed to sit for 10 minutes. A standard suspension consisted of 10 ml of the 10:1 diluted stock suspension was added to a 17 mL glass vial.

### Observations and Measurements.

The observations of Comparative Example 1 were repeated.

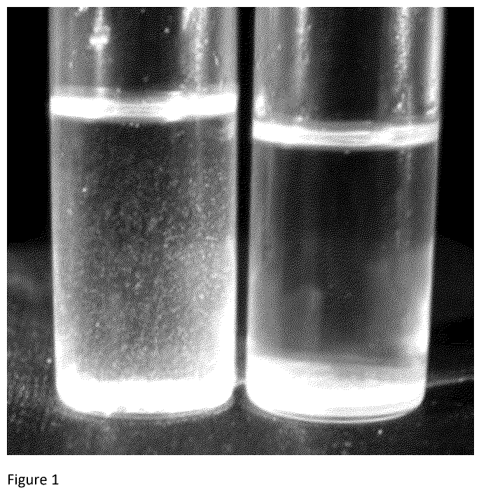

FIG. 1 shows the standard and sample vial, showing the visible particles in the standard are removed by the action of the particle capturing polymer. Particles were easily seen moving in the liquid under focused white light illumination in the standard. No particles were visible under focused white light illumination in the vial with containing the melted gel window cling. Particles could be seen adhered to the solid particle capturing material.

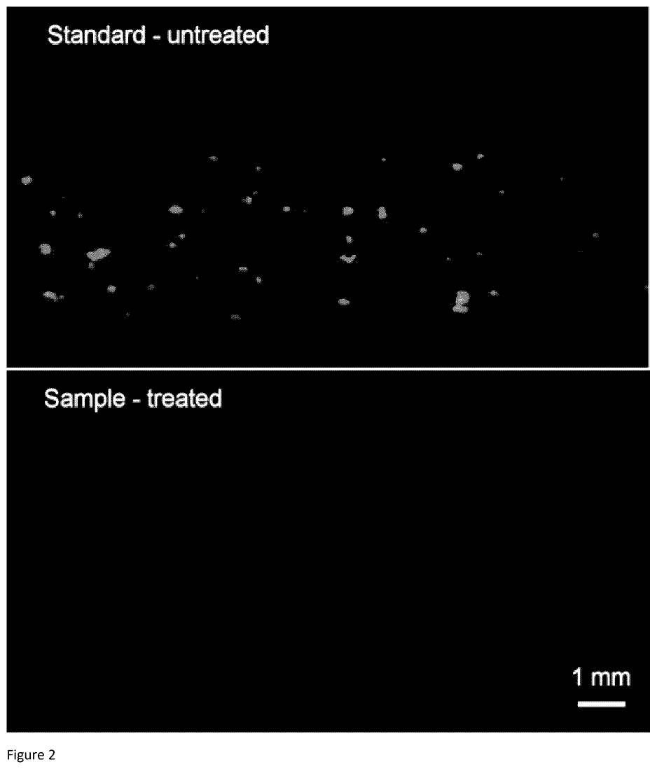

Illumination with the 5 mW red laser while observing showed clearly visible particles in the standard suspension. None could be seen in the vial containing the melted gel window cling. Micrographs taken were analyzed with OpenFCU [Geissmann, Quentin. “OpenCFU, a new free and open-source software to count cell colonies and other circular objects.” PloS one 8, no. 2 (2013): e54072.] for counting particles present. Over 200 particles were detected in the standard. The sample, over the particle capture material, showed no particles. FIG. 2 contains photographs of the standard and sample illuminated with the 5 mW red laser. Scattering events are captured in the photograph of the standard. None are captured in the sample after particle capture.

Illumination with the 5 mW green laser showed many scattering events in the standard, well more than 1000. Few, approximately 5, were observed in the vial containing the melted gel window cling.

Taken together, these observations demonstrate the utility of particle capturing solids for reduction or elimination of micro- and nanoparticles from beverages and other liquids.

### Example 2

Vodka (Grey Goose brand) was used to triple rinse two 17 mL glass vials. The vodka is in a glass bottle with a plastic stopper. Approximately 10 ml of vodka was poured directly from the bottle into two 17 ml vials. One is the standard. The sample vial was treated with particle catching polymer.

### Preparation of Particle Capturing Polymer.

A commercially available zinc coated steel star washer, #10 size, was placed on a stainless steel surface. 0.01 g piece of gel window cling (Hobby Lobby brand) was placed in the hole of the washer. Heat from a heat gun was applied to the underside of the stainless steel sufficient to melt the polymer. A thermocouple measured the melting point at approximately 90° C. Heating was discontinued and all were allowed to cool. The washer and polymer device was examined using an optical microscope to ensure the surface was particle free. The cooled washer and polymer device was then added to the second vial and swirled.

### Observations and Measurements.

The observations of Comparative Example 1 were repeated.

Particles were easily seen under focused white light illumination in the standard. No particles were visible under focused white light illumination in the vial containing the washer and polymer device.

Illumination of both vials with a 5 mW red laser showed a low and changing number of particles in the standard and no particles present in sample containing the washer and polymer device. Counts from multiple images from the standard were averaged giving an estimated microparticle concentration of less than 10 particles/mL.

Experiments were repeated with the 5 mW green laser. Counts from multiple images were again averaged yielding approximately 850 particles/mL in the standard. This was reduced by the presence of the washer and polymer device to less than 400 particles/mL.

A magnet was used to recover the washer and polymer device. Examination under a microscope showed particles on the polymer surface. The optical microscope was operated in reflectance mode to clearly see only particles on the polymer surface. A needle was used to probe the particles further confirming they were on the surface.

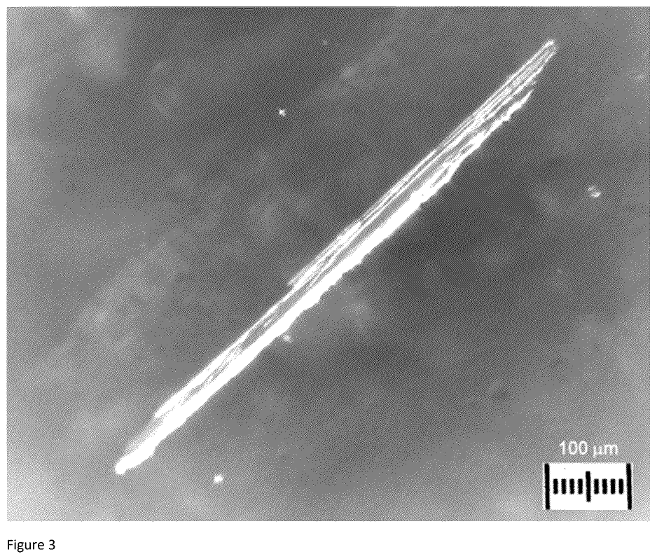

FIG. 3 shows a micrograph photo of the washer and polymer device after removal from the vodka sample. One large and several smaller particles are visible adhering to the particle capturing polymer.

Taken together, these observations demonstrate the utility of particle capturing solids and devices made with them for reduction or elimination of micro- and nanoparticles from beverages and other liquids.

### Example 3

Coffee made using a coffee pod was prepared following the device directions (Keurig) using a purchased pod (Pikes Place® Roast brand). A device made as described below was used to stir the coffee. It was removed from the coffee and shaken to remove liquid. It was examined using an optical microscope.

Preparation of the particle capturing polymer and device: A 0.02 g piece of gel window cling polymer (Hobby Lobby brand) was placed on a 75 by 26 mm glass microscope slide. The slide was heated from below to melt the polymer forming approximately a 20 mm circle adhering to the glass. It was allowed to cool to room temperature.

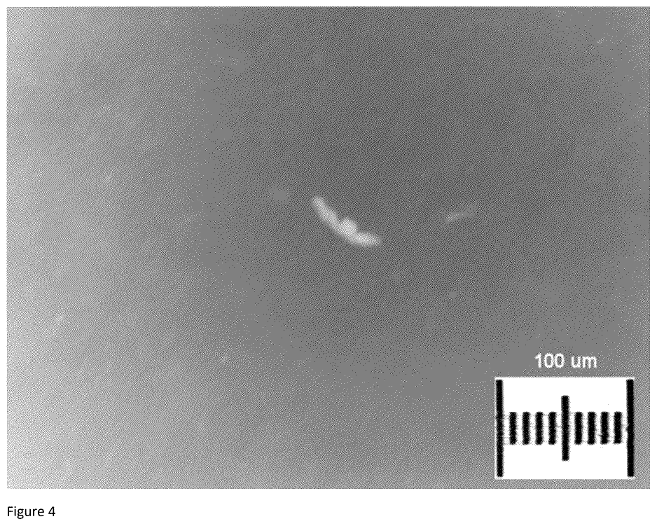

Observations and measurements: Prior to placement in the liquid, the polymer adhering to the glass microscope slide was examined to ensure it was free of particle contamination both under visible and UV-C (365 nm) illumination. Upon removal from the coffee, it was examined again under reflected (rather than transmitted) light showing particles adhering to the exposed surface of the polymer. Examination under UV-C light showed some of the captured particles were fluorescent. FIG. 4 shows particles captured on the polymer surface of the device. Taken together, these observations demonstrate the utility of particle capturing solids and devices made with them for reduction or elimination of micro-and nanoparticles from beverages and other liquids.

### Example 4

Commercial bottled water. A 500 mL container of commercial bottled water (Meijer spring water) was examined with focused white light from an LED flashlight. Under bright light, particles were observed after swirling the bottle taking care not to entrain bubbles from the headspace. The bottle was vigorously shaken, opened and used to triple rinse a 10 ml glass vial. 7 mL was poured into the rinsed 10 mL glass vial to serve as the standard. A 13 mm (½ inch) repositionable glue dot (Glue Dots adhesives brand, Glue Dots International) was pressed into the lid of the bottle. The adhesive is sold on a roll of release paper. The release paper was used to press the dot into the lid and then removed. The lid, now containing the particle capturing material, was replaced on the bottle. The bottle was inverted, swirled and left for 10 minutes. After 10 minutes, the bottle was examined as before with the focused LED flashlight. Water from the bottle was used to triple rinse a 10 mL vial. 7 mL was poured into the vial. This is the sample.

### Observations and Measurements.

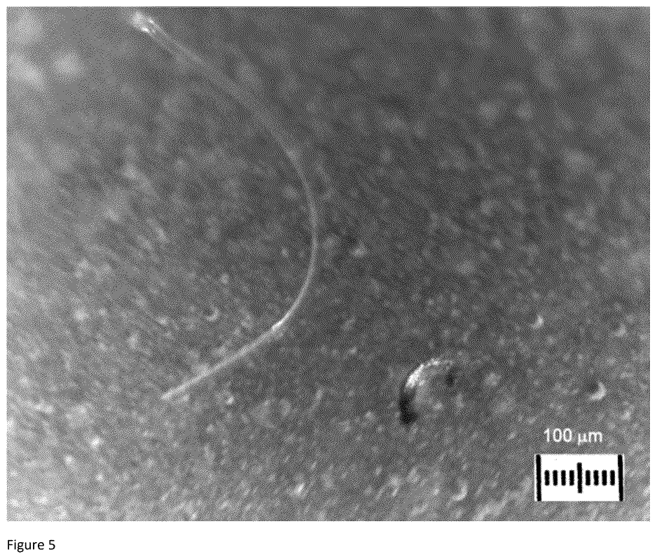

No particles were observed in the 500 ml water bottle after treatment. The lid was removed and the polymer dot transferred to a microscope slide for examination. Examination under reflected light showed particles attached to the exposed surface of the glue dot. FIG. 5 is a micrograph showing particles captured on the surface of the particle capturing polymer. These observations demonstrate the utility of particle capturing solids and devices made with them for reduction or elimination of micro-and nanoparticles from bottled water.

### Example 5

Commercial water packaged in a coated paper carton. A carton of Flow brand water packaged in a coated paper carton with a screw lid was purchased. The carton was vigorously shaken, opened, used to triple rinse two 17 mL glass vial. 10 mL was poured into each of the rinsed 10 mL glass vials. One vial was left untouched to serve as the standard. The other vial had a device made using polymeric particle capturing material inserted.

### Preparation of the Particle Capturing Polymer and Device:

A 0.01 g piece of gel window cling polymer (Hobby Lobby brand) was placed in the center of a #8 star washer on a piece of stainless steel sheet metal. The washer was selected as the largest outer diameter capable of fitting into the mouth of a 17 mL glass vial. The stainless steel was heated from below sufficient to melt the polymer. The device, made from washer and polymer, was allowed to cool. Once at room temperature, the device was peeled from the stainless steel and inserted into the lid of the sample vial where it was retained by a magnet. The vial was swirled, inverted (top down) and allowed to sit for approximately 15 minutes. It was returned to the lid-up configuration and the lid removed with the magnetically retained washer and polymer device. The washer and polymer device was transferred to a microscope slide for examination.

### Observations and Measurements.

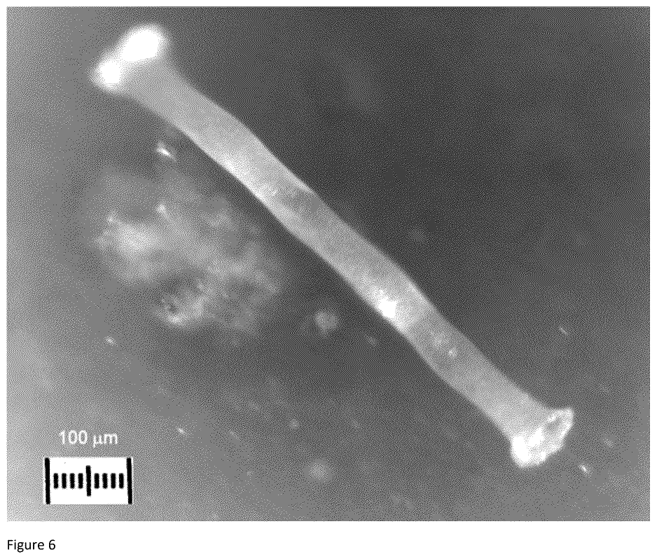

Particles were observable in both vials immediately after addition of water under focused white light. After exposure to the device, washer and polymer, for 15 minutes, no particles could be observed in the exposed sample. The standard, untreated, still had observable particles. The device, consisting of the washer and polymer, was transferred to a glass microscope slide for examination. Microparticles were found collected on the particle capturing polymer surface. FIG. 6 is a micrograph of one of the collected particles captured on the surface of particle capturing polymer.

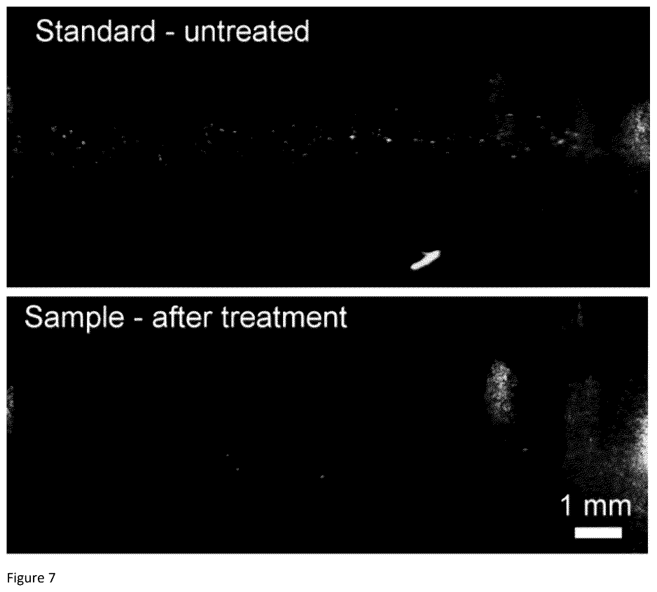

Illumination with the 5 mW green laser showed clear evidence of Rayleigh scattering in both the standard and sample. There are far fewer scattering events in the sample after treatment with the device using particle capturing polymer. FIG. 7 shows a comparison of the scattering events observed in the standard and sample under the same conditions. It shows a marked reduction in scattering events after treatment with a device using a particle capturing polymer. These observations demonstrate the utility of particle capturing solids and devices made with them for reduction or elimination of micro- and nanoparticles from bottled water.

### Example 6

Contact lens solution. A sample of commercial contact lens solution (Bausch+Lomb Sensitive Eyes® Saline Solution) was used to triple rinse two 10 mL glass vials. The contact lens solution was vigorously shaken and approximately 7 mL was added to each vial. A device, consisting of a steel washer and gel window cling was prepared as in Example 5. Just as in Example 5, the cooled device, washer and polymer, were added to one of the vials to form the sample. The remaining vial was the standard. It was allowed to contact the solution for 15 minutes prior to removal with a magnet and tweezers. The device, washer and polymer, were transferred to a glass microscope slide.

### Observations and Measurements.

Particles were observable in both vials immediately after addition of water under focused white light. After exposure to the device, washer and polymer, for 15 minutes, no particles could be observed in the exposed sample. The standard, untreated, still had observable particles. The device, consisting of the washer and polymer, was transferred to a glass microscope slide for examination. Multiple microparticles were found on the particle capturing polymer surface.

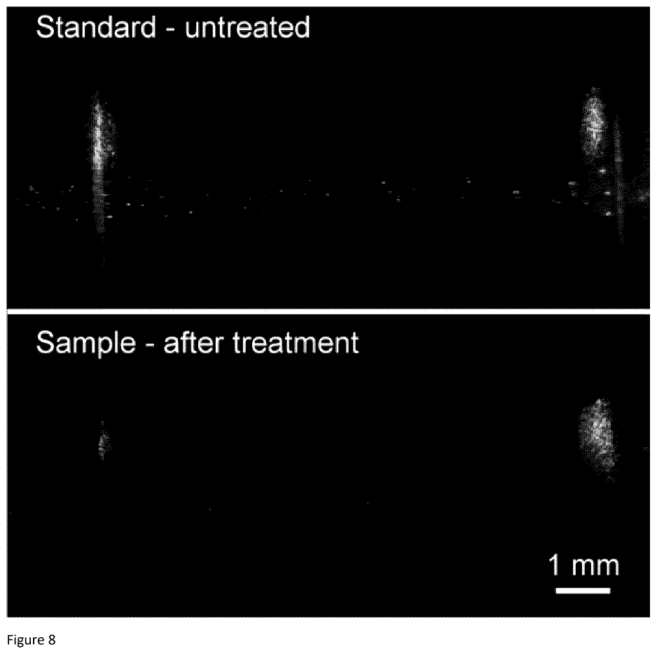

Illumination with the 5 mW green laser showed clear evidence of Rayleigh scattering in both the standard and sample. There are far fewer scattering events in the sample after treatment with the device using particle capturing polymer. FIG. 8 shows a comparison of the scattering events observed in the standard and sample under the same conditions. It shows a marked reduction in scattering events after treatment with a device using a particle capturing polymer. These observations demonstrate the utility of particle capturing solids and devices made with them for reduction or elimination of micro- and nanoparticles from a water-based, commercial, non-beverage liquid.

### Example 7

Use of coconut oil to capture plastic particles. Two suspensions were prepared from a commercial water bottle (Meijer spring water), one from the bottle, one from the lid. A ½″-inch fine abrasive cylindrical grinding bit is put on the umbilical high-speed grinder. 35 mL of distilled water is added to a 65 mm glass jar. The rotating bit is held under water but not touching the bottom of the container. The rim of the water bottle is contacted for a period of about 30 seconds. This produces a translucent, milky liquid with some visible particles. The suspension is filtered through 110-120 mesh filters, nominally passing 125 micrometer particles, yielding a suspension with visible particles. The bottle was labeled with a number 1 indicating polyethylene terephthalate (PET). After rinsing the glass jar, 35 mL of distilled water is added and the process repeated with the lid of the water bottle. After about 30 seconds a translucent, milky liquid with some visible particles is made. The suspension is filtered through 110-120 mesh filters, nominally passing 125 micrometer particles, yielding a suspension with visible particles. The lid was uncolored, natural polymer, labeled with the number 2 recycling symbol, indicating high-density polyethylene (HDPE). 15 mL of each suspension is combined to produce a mixed PET+PE suspension. Two 10 ml vials are prepared by triple rinsing with distilled water. Approximately 7 mL of the mixed PET+PE suspension was added to each. One was set aside as the standard. 3 grams of solid coconut oil (Clover Valley brand) were added forming the sample. The sample vial, with no lid, was heated in a microwave oven until the coconut oil began turning from opaque white to clear, indicating it had begun to melt (approximately 10 seconds). The vial was capped and the coconut oil continued to melt. The vial was hot to the touch but showed no evidence of boiling. Once the coconut oil was fully melted, the vial was vigorously shaken for approximately 10 seconds. The vial was then allowed to cool in an 18.3° C. room. The cooled vial, after about 1 hour, was tested.

### Observations and Measurements.

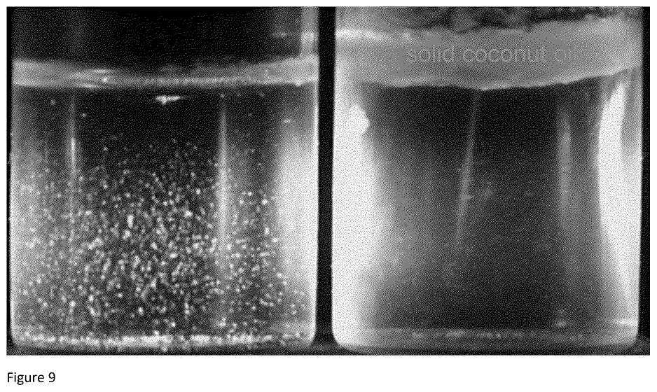

The cooled sample vial had a layer of solid, opaque white coconut oil over an aqueous phase. Particles were observable in standard sample under focused white light. None were observed under identical illumination in the aqueous layer below the solid coconut oil in the sample vial. FIG. 9 shows a comparison of the standard and sample vials illuminated from the side with focused white light. Particles are clearly visible in the standard. None are observed in the sample.

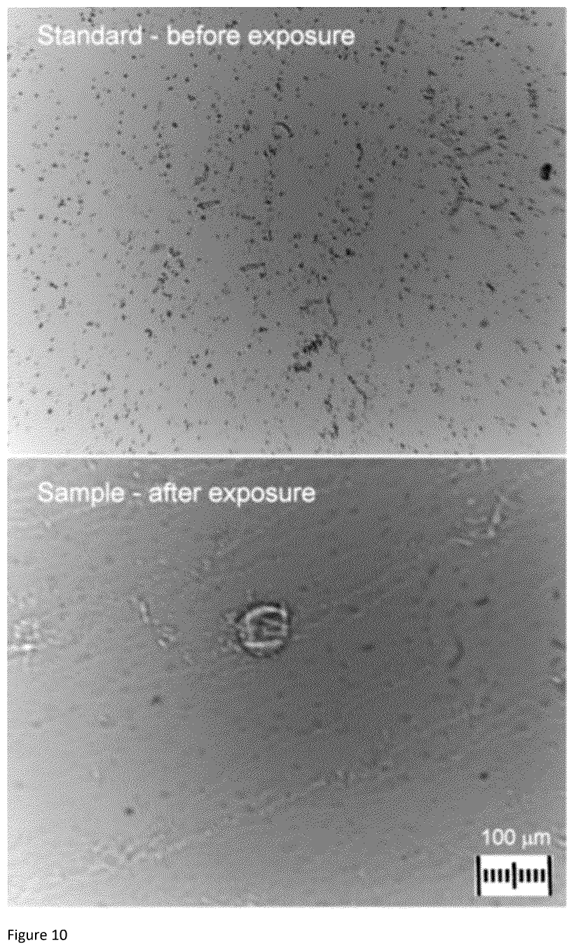

A transfer pipette was used to get a small sample from the aqueous layer. The solid coconut oil was floating on the aqueous layer and tipped out of the way to allow the sample to be taken. A drop was applied to a microscope slide. A drop from the standard was applied to a different microscope slide. Both slides were dried by heating in a microwave to 2 minutes. Visual examination showed an area of visible particles with a solid white perimeter in the standard. Examination with the microscope showed many particles in the standard. The sample slide showed a much more subtle perimeter where the drop had been deposited. Microscopic examination showed what appeared to be oil droplets. No particles were observed. FIG. 10 shows a comparison of the dried sample and standard under identical microscopic examination.

1. A method for removing plastic micro- and nanoparticles from water, beverages or other liquids by trapping using a particle capturing polymer.

2. The method of claim 1 where the capturing polymer is a resilient thermoplastic polymer.

3. The method of claim 1 where the particle capturing polymer is a pressure sensitive adhesive, a gel window cling polymer or a fugitive adhesive.

4. The method of claim 1 where the particle capturing polymer is a water insoluble lipophilic polymer.

5. The method of claim 1 where the particle capturing polymer is a thermoplastic polyolefin, polyolefin elastomer, polyolefin plastomer, or a styrenic block copolymer.

6. A device for removing microplastic and nanoplastic particles from water, beverages or other liquids by trapping using a particle capturing polymer.

7. The device of claim 6 where the capturing polymer is a resilient thermoplastic polymer.

8. The device of claim 6 where the particle capturing polymer is a pressure sensitive adhesive, a gel window cling polymer or a fugitive adhesive.

9. The device of claim 6 where the particle capturing polymer is a water-insoluble lipophilic polymer.

10. The device of claim 6 where the particle capturing polymer is a thermoplastic polyolefin, polyolefin elastomer, polyolefin plastomer, or a styrenic block copolymer.

11. A device of claim 6 for removing plastic micro- and nanoparticles from water, beverages or other liquids by trapping particles using a formed piece of particle capturing material placed in a bottle.

12. A device of claim 6 for removing plastic micro- and nanoparticles from water, beverages or other liquids by trapping particles using a thermoplastic polymer formed as a disc placed in a bottle.

13. A device of claim 6 for removing plastic micro- and nanoparticles from water, beverages or other liquids by trapping particles using a thermoplastic polymer melted or otherwise attached to an object such as, but not limited to, a metal washer, a spoon, a stirring device, straw or other item.

14. The device of claim 13 where the polymer is a fugitive adhesive.

15. The device of claim 13 where the structure can be, but is not limited to, metal, glass, plastic, ceramic, paper or wood.

16. A method of claim 1 for removing plastic micro- and nanoparticles from water, beverages or other liquids by trapping particles using a water insoluble, lipophilic polymer present in a bottle prior to filling and remaining in the bottle throughout the supply chain.

17. A method for removing plastic micro- and nanoparticles from water, beverages or other liquids by contacting a lipophilic, water immiscible seed oil, chemically modified seed oil, seed oil derivative or wax that is solid at room temperature with the particle containing liquid where the lipophilic, water immiscible seed oil, chemically modified seed oil, seed oil derivative, or wax that is solid at room temperature can be easily removed or otherwise avoided during consumption or use.

18. A method of claim 17 for removing plastic micro- and nanoparticles from water, beverages or other liquids by contacting a lipophilic, water immiscible seed oil, chemically modified seed oil, or wax that is solid at room temperature with the particle containing liquid at a temperature where the lipophilic, water immiscible seed oil, chemically modified seed oil, seed oil derivative or wax becomes liquid and subsequently allowing cooling sufficient to return the lipophilic, water immiscible seed oil, chemically modified seed oil, or wax to the solid state to be removed or otherwise avoided during consumption or use.

19. The method of claim 17 where coconut oil or hydrogenated vegetable oil is used.

20. The method of claim 18 where coconut oil, paraffin wax or hydrogenated vegetable oil is used.
